(19) United States
(12) Patent Application Publication
(10) Pub. No.: US 2006/0174320 A1
(43) Pub. Date: Aug. 3, 2006

(54) System and method for efficient configuration of group policies

(75) Inventors: Vishal D. Maru, Bellevue, WA (US); Geanina Andreiu, Redmond, WA (US); Maxim Oustiougov, Seattle, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/048,036

(22) Filed: Jan. 31, 2005

(51) Int. Cl. H04L 9/00

(52) U.S. Cl. 726/1

(57) ABSTRACT

A registry of system information may have several sections. Group policies may be represented by entries in particular sections of the registry. A policy map may map group policies to the sections and entries of the registry. A policy map registry section field of the policy map may specify one or more sections of the registry to which group policies are mapped. The policy map may include one or more registry variable policy map fields, each of which may specify mappings for different types of registry variables. A configuration file repository may include sets and versions of policy configuration files that include policy maps. A group policy configuration tool may retrieve and parse policy maps, and update group policies corresponding to the policy maps.

### FIELD OF THE INVENTION

This invention pertains generally to computing devices and, more particularly, to configuration of computing devices.

### BACKGROUND OF THE INVENTION

Computers have become complex and may require significant effort to configure. The configuration challenge is compounded in environments that include networks and arrays of computers, and particularly in environments where computers are removed and new computers are added over time. Several mechanisms have been developed to manage this complexity, but each has limitations.

Graphical user interfaces (GUI) have become popular mechanisms for configuring computers. However, as the number of computer configuration options grow, a graphical user interface for configuration of those options may become cumbersome and error prone, particularly when a complicated set of configuration changes is being implemented. In addition, few graphical user interfaces for computer configuration have robust configuration versioning mechanisms. If a configuration change causes instability, there may not be a reliable way of reverting to a previous stable configuration set with a particular graphical user interface.

Computer configuration testing in particular may require repeated, complicated configuration set changes, as well as an ability to identify, record and implement a particular computer configuration. Tools have been developed that manipulate conventional graphical user interfaces for configuring computers, but many of these tools are themselves cumbersome and error prone. They may have fragile dependencies upon the details of a particular graphical user interface, and those details may change as a computer implementing the graphical user interface is reconfigured. For example, a tool may depend upon the natural language (e.g., English, French, Spanish) displayed by a graphical user interface and may itself need to be reconfigured for each different language.

One conventional way to manage configuration complexity is to organize computers and users of computers into domains and groups. Policies determining configuration may then be applied to entire domains. However, computers in domains are typically organized into one of a limited set of topographies such as a hierarchy. The organization may achieve one particular configuration goal while actually hindering a variety of other configuration goals and, in particular, transient but high priority reconfiguration needs such as responding to a security breach and/or threat.

### BRIEF SUMMARY OF THE INVENTION

This section presents a simplified summary of some embodiments of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

A registry of system information may have several sections. Group policies may be represented by entries in particular sections of the registry. A policy map may map group policies to the sections and entries of the registry. A policy map registry section field of the policy map may specify one or more sections of the registry to which group policies are mapped. The policy map may include one or more registry variable policy map fields, each of which may specify mappings for different types of registry variables. A configuration file repository may include sets and versions of policy configuration files that include policy maps. In an embodiment of the invention, a group policy configuration tool retrieves and parses policy maps, and updates group policies corresponding to the policy maps.

### BRIEF DESCRIPTION OF THE DRAWINGS

While the appended claims set forth the features of the invention with particularity, the invention and its advantages are best understood from the following detailed description taken in conjunction with the accompanying drawings, of which:

FIG. 1 is a schematic diagram generally illustrating an exemplary computer system usable to implement an embodiment of the invention;

FIG. 2 is a schematic diagram illustrating an example computing environment suitable for incorporating embodiments of the invention;

FIG. 3 is a schematic diagram illustrating an example architecture incorporating a group policy configuration tool in accordance with an embodiment of the invention;

FIG. 4 is a schematic diagram depicting an example policy map in accordance with an embodiment of the invention;

FIG. 5 is a flowchart depicting example steps for configuration of group policies in accordance with an embodiment of the invention; and

FIG. 6 is a flowchart depicting further example steps for configuration of group policies in accordance with an embodiment of the invention.

### DETAILED DESCRIPTION OF THE INVENTION

Prior to proceeding with a description of the various embodiments of the invention, a description of a computer in which the various embodiments of the invention may be practiced is now provided. Although not required, the invention will be described in the general context of computer-executable instructions, such as program modules, being executed by a computer. Generally, programs include routines, objects, components, data structures and the like that perform particular tasks or implement particular abstract data types. The term “program” as used herein may connote a single program module or multiple program modules acting in concert. The terms “computer” and “computing device” as used herein include any device that electronically executes one or more programs, such as personal computers (PCs), hand-held devices, multi-processor systems, microprocessor-based programmable consumer electronics, network PCs, minicomputers, tablet PCs, laptop computers, consumer appliances having a microprocessor or microcontroller, routers, gateways, hubs and the like. The invention may also be employed in distributed computing environments, where tasks are performed by remote processing devices that are linked through a communications network. In a distributed computing environment, programs may be located in both local and remote memory storage devices.

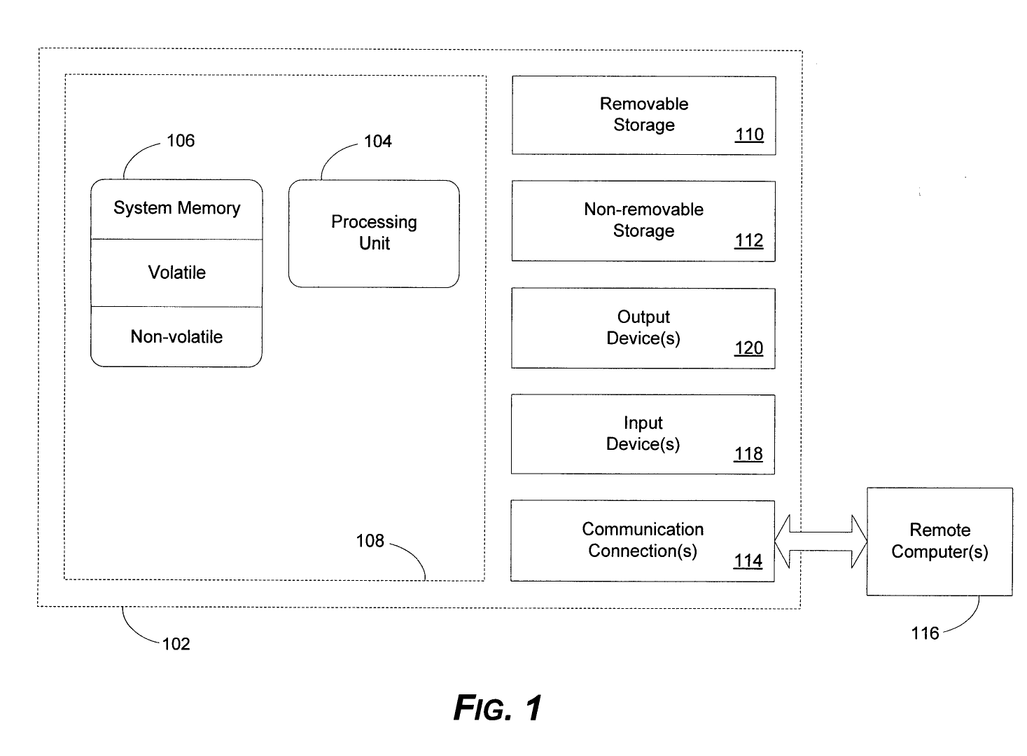

Referring to FIG. 1, an example of a basic configuration for the computer 102 on which aspects of the invention described herein may be implemented is shown. In its most basic configuration, the computer 102 typically includes at least one processing unit 104 and memory 106. The processing unit 104 executes instructions to carry out tasks in accordance with various embodiments of the invention. In carrying out such tasks, the processing unit 104 may transmit electronic signals to other parts of the computer 102 and to devices outside of the computer 102 to cause some result. Depending on the exact configuration and type of the computer 102, the memory 106 may be volatile (such as RAM), non-volatile (such as ROM or flash memory) or some combination of the two. This most basic configuration is illustrated in FIG. 1 by dashed line 108.

The computer 102 may also have additional features/functionality. For example, computer 102 may also include additional storage (removable 110 and/or non-removable 112) including, but not limited to, magnetic or optical disks or tape. Computer storage media includes volatile and non-volatile, removable and non-removable media implemented in any method or technology for storage of information, including computer-executable instructions, data structures, program modules, or other data. Computer storage media includes, but is not limited to, RAM, ROM, EEPROM, flash memory, CD-ROM, digital versatile disk (DVD) or other optical storage, magnetic cassettes, magnetic tape, magnetic disk storage or other magnetic storage devices, or any other medium which can be used to stored the desired information and which can be accessed by the computer 102. Any such computer storage media may be part of computer 102.

The computer 102 preferably also contains communications connections 114 that allow the device to communicate with other devices such as remote computer(s) 116. A communication connection is an example of a communication medium. Communication media typically embody computer readable instructions, data structures, program modules or other data in a modulated data signal such as a carrier wave or other transport mechanism and includes any information delivery media. By way of example, and not limitation, the term “communication media” includes wireless media such as acoustic, RF, infrared and other wireless media. The term “computer-readable medium” as used herein includes both computer storage media and communication media.

The computer 102 may also have input devices 118 such as a keyboard/keypad, mouse, pen, voice input device, touch input device, etc. Output devices 120 such as a display, speakers, a printer, etc. may also be included. All these devices are well known in the art and need not be described at length here.

In the description that follows, the invention will be described with reference to acts and symbolic representations of operations that are performed by one or more computing devices, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

In an embodiment of the invention, a system and method is provided for efficient configuration of computers such as the computer 102. In particular, each member of an arbitrary set of computers may be configured with a specified set of group policies. A group policy configuration tool may configure the set of computers from one or more of a plurality of sets and versions of group policy configuration files that include policy maps.

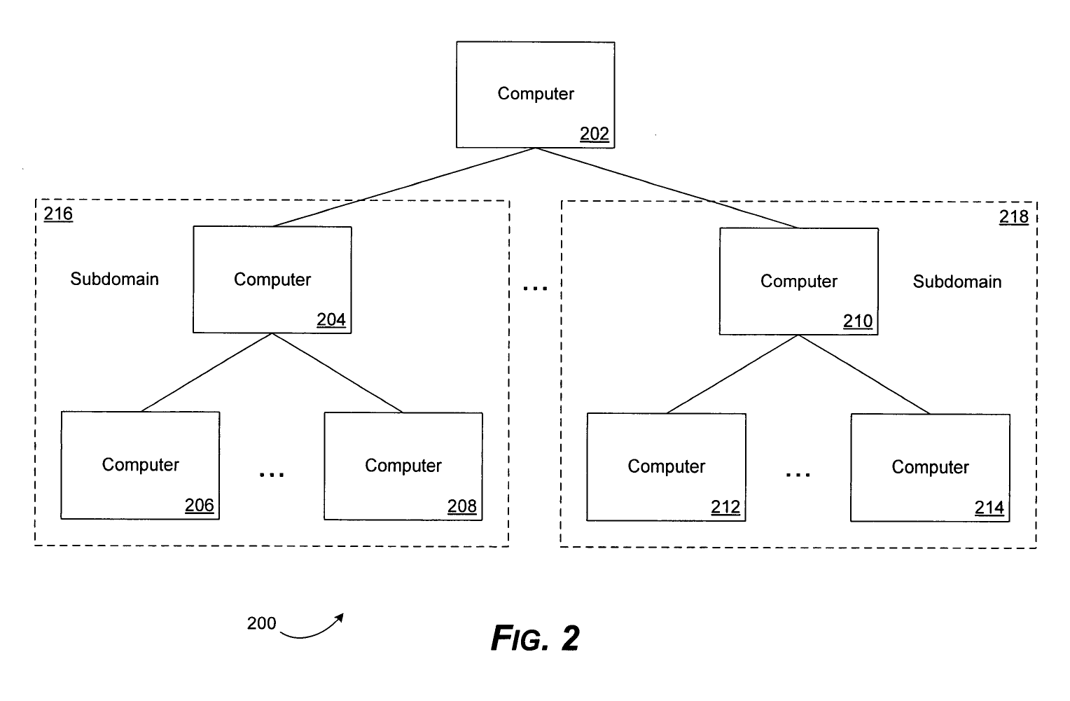

Computers may be organized into networks, arrays and/or domains. FIG. 2 depicts an example computing environment 200 suitable for incorporating embodiments of the invention. The computing environment 200 may include computers 202, 204, 206, 208, 210, 212, 214 organized in a domain or configuration hierarchy. Computers higher in the hierarchy may propagate configuration settings to computers lower in the hierarchy. For example, the computer 202 may propagate configuration settings to computers 204 and 210.

The computing environment 200 may further include a plurality of subdomains such as subdomain 216 and subdomain 218. Computers within each subdomain 216, 218 may be separately configured. The computer 204 may propagate configuration settings to computers 206 and 208. The computer 210 may propagate configuration settings to computers 212 and 214. The computers 202, 204 and 210 may be configured as domain controllers, for example, as domain controllers implementing Active Directory® services as described in the Active Directory section of the Microsoft® Windows® Platform Software Development Kit (SDK) in the Microsoft Developer Network (MSDN®) Library dated October, 2004.

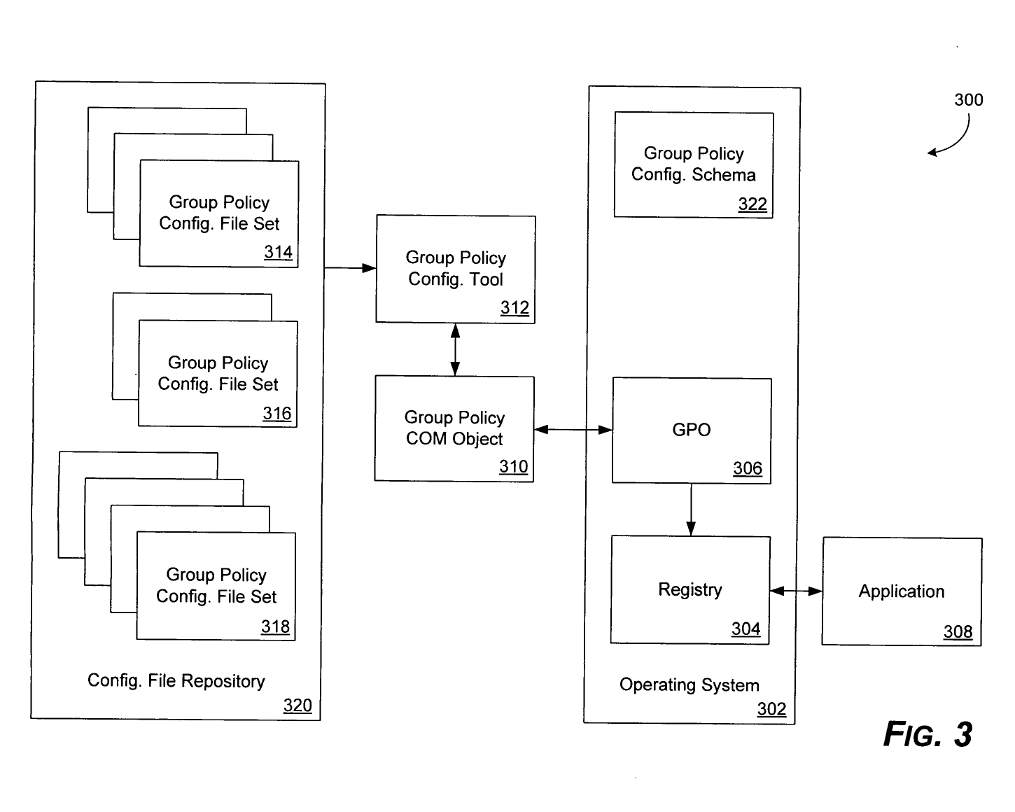

An example architecture 300 incorporating the group policy configuration tool for configuring an arbitrary set of the computers 202, 204, 206, 208, 210, 212, 214 in accordance with an embodiment of the invention will now be described with reference to FIG. 3. An operating system 302 for a computer (e.g., any of the computers 202, 204, 206, 208, 210, 212, 214 of FIG. 2) includes a registry 304 of system information. For example, the operating system 302 may be a Microsoft® Windows® computer operating system and the registry 304 may have the attributes and behavior described by the Registry topic of the Windows System Information section of the Microsoft® Windows® Platform Software Development Kit (SDK) in the Microsoft Developer Network (MSDN®) Library dated December, 2004. However, embodiments of the invention are not so limited and the operating system 302 may be any suitable computer operating system and the registry 304 may be any suitable registry of system information, registry of a computer operating system, and/or computer operating system registry.

The operating system 302 may further include one or more group policy objects (GPO) 306 that specify one or more group policies for computers 202, 204, 206, 208, 210, 212, 214 (FIG. 2) and users of computers 202, 204, 206, 208, 210, 212, 214. Examples of group policies suitable for an embodiment of the invention include policies for specifying system behavior, application settings, security settings, assigned and published applications, computer startup and shutdown scripts, user logon and logoff scripts and folder redirection. Example context and details for a group policy architecture and, in particular, group policy objects suitable for incorporation in an embodiment of the invention may be found in the Group Policy section of the Microsoft® Windows® Platform Software Development Kit (SDK) in the Microsoft Developer Network (MSDN®) Library dated October, 2004.

The registry 304 may have areas and sections. Different areas and sections of the registry 304 may have different security permissions, for example, access and modification permissions, and those security permissions may be different for different computer users and groups of users. The group policy objects 306 may be applied to the registry 304. To prevent unauthorized modification, the group policy objects 306 may be applied to areas and/or sections of the registry 304 that are tamper resistant and/or read-only with respect to one or more computer users or groups of computer users. The operating system 302 and application programs such as an application 308 may enforce group policies at computers 202, 204, 206, 208, 210, 212, 214 (FIG. 2) in accordance with registry 304 entries, that is, the group policies may be registry-based policies.

The group policy objects 306 may be created, read, updated and deleted with a group policy component object model (COM) object 310. A group policy configuration tool 312 may create, read, update and delete the group policy objects 306 through an application programming interface (API) of the group policy COM object 310. The group policy configuration tool 312 may create, read, update and delete the group policy objects 306 as specified by policy maps contained in one or more group policy configuration files 314, 316, 318 in a configuration file repository 320.

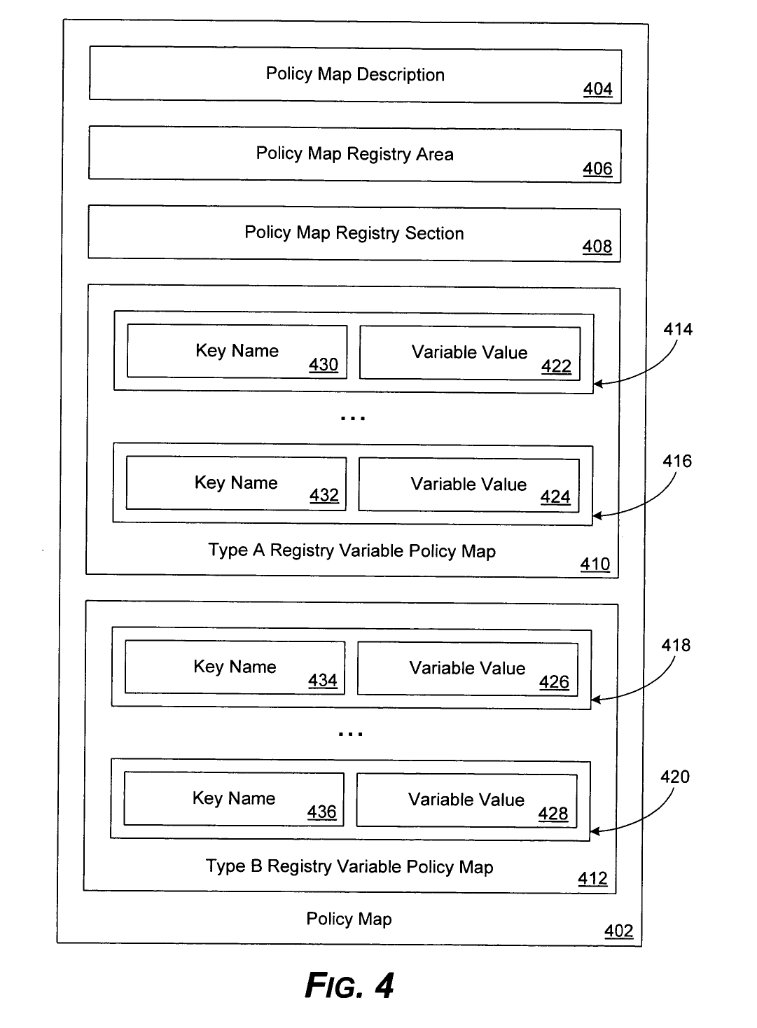

The configuration file repository 320 may be part of a computer file system, a computer database, and/or any suitable computer-readable medium. The group policy configuration files 314, 316, 318 may be organized into sets of files and/or into sets of versions of files. Each group policy configuration file 314, 316, 318 may include data structured with a markup language, for example, an extensible markup language (XML) in accordance with the World Wide Web Consortium® (W3C®) Recommendation titled Extensible Markup Language (XML) 1.0 (Third Edition) dated Feb. 4, 2004. Each group policy configuration file 314, 316, 318 may include one or more policy maps. Further details of policy maps are described below and, in particular, with reference to FIG. 4.

The operating system 302 may further include a group policy configuration schema 322. Each group policy configuration file 314, 316, 318 and/or each policy map may be structured in accordance with the group policy configuration schema 322. The group policy configuration schema 322 may specify suitable values for elements of group policy configuration files 314, 316, 318 and/or policy maps. Although a conventional document type definition (DTD) is a suitable format for the group policy configuration schema 322, embodiments of the invention are not so limited. In an embodiment of the invention, the group policy configuration schema is an administrative template file (“.adm file”) having a format in accordance with the format described by the Administrative Template File Format topic of the Group Policy section of the Microsoft® Windows® Platform Software Development Kit (SDK) in the Microsoft Developer Network (MSDN®) Library dated October, 2004.

Arrows between components 304, 306, 308, 310, 312 and 320 of FIG. 3 indicate aspects of data flow through the architecture 300. The group policy configuration tool 312 may read in group policy configuration files 314, 316, 318 from the configuration file repository 320. The group policy configuration tool 312 may interact with an interface (e.g., a COM interface) of the group policy COM object 310. For example, the group policy configuration tool 312 may instantiate objects and invoke methods of the interface of the group policy COM object 310 in accordance with policy maps contained in the group policy configuration files 314, 316, 318.

The group policy COM object 310 may create, read, update and/or delete group policy objects 306. Although not shown in FIG. 3, in an embodiment of the invention, the group policy COM object 310 may create, read, update and/or delete entries in the registry 304. Group policy objects 306 may be applied to the registry 304. For example, the operating system 302 may apply group policy objects 306 to the registry 304 in accordance with a security policy. Applying group policy objects 306 to the registry 304 may include creating, reading, updating and/or deleting entries of the registry 304. The application 308 may configure its own representations of group policies from registry 304 entries.

Before describing examples steps performed by components of FIG. 3 in more detail, it will be helpful to described further details of policy maps such as those that may be contained in group policy configuration files 314, 316 and 318. FIG. 4 depicts an example policy map 402 in accordance with an embodiment of the invention. The policy map 402 may map a group policy to one or more registry 304 (FIG. 3) locations. The policy map 402 may define a unique map from the group policy to the registry 304. Each group policy configuration file 314, 316, 318 may include one or more policy maps such as the policy map 402. The policy map 402 may include one or more data fields such as a policy map description 404, a policy map registry area 406, a policy map registry section 408, a type A registry variable policy map 410 and a type B registry variable policy map 412.

The policy map description 404 may include a human-readable description of the group policy being mapped, for example, an alphanumeric text string. The registry 304 (FIG. 3) may include a plurality of areas. For example, the registry 304 may include a local machine area for entries associated with the computer 102 (FIG. 1) implementing the registry 304, and a user area for entries associated with users and/or groups of users of the computer 102. The policy map registry area 406 may specify one or more of the plurality of registry 304 areas to which to map the group policy associated with the policy map 402. In an embodiment of the invention, the policy map registry area 406 is an extensible markup language element having a flag attribute indicating whether or not the group policy should be mapped to the local machine area of the registry 304.

The registry 304 (FIG. 3) may include a plurality of sections. In an embodiment of the invention, the sections of the registry 304 are organized in a hierarchy analogous to a directory hierarchy of a conventional computer file system. A particular registry section may be specified by a path through the hierarchy, for example, an alphanumeric string including a name of each section in the path. Like named sections of the registry 304 may occur in different areas of the registry 304. The policy map registry section 408 may specify the registry section to which to map the group policy associated with the policy map 402. In an embodiment of the invention, the policy map registry section 408 is an extensible markup language element having a path attribute.

Each section of the registry 304 (FIG. 3) may include one or more variables. Each registry variable may be associated with a name or key. Each registry variable may be one of a plurality of types of registry variable. For example, types of registry variable may include binary type variables and string type variables. The type of a registry variable may determine how the registry variable is interpreted and/or handled, for example, by the operating system 302 and the application 308.

Each of the type A registry variable policy map 410 and the type B registry variable policy map 412 may include a plurality of name-value pairs 414, 416, 418, 420 each associating a variable value 422, 424, 426, 428 with a key name 430, 432, 434, 436. The type A registry variable policy map 410 may specify group policy mappings for a first type of registry variable. The type B registry variable policy map 412 may specify group policy mappings for a second type of registry variable. For example, the type A registry variable policy map 410 may specify group policy mappings for binary type registry variables and the type B registry variable policy map 412 may specify group policy mappings for string type registry variables.

In an embodiment of the invention, the type A registry variable policy map 410 is a first extensible markup language element, the type B registry variable policy map 412 is a second extensible markup language element, and the name-value pairs 414, 416, 418, 420 are attributes of the first and the second extensible markup language elements. In an embodiment of the invention, each key name 430, 432, 434, 436 corresponds to a registry key name specified in the group policy configuration schema 322 (FIG. 3) and each variable value 422, 424, 426, 428 corresponds to one of a set of valid registry variable values specified in the group configuration schema 322.

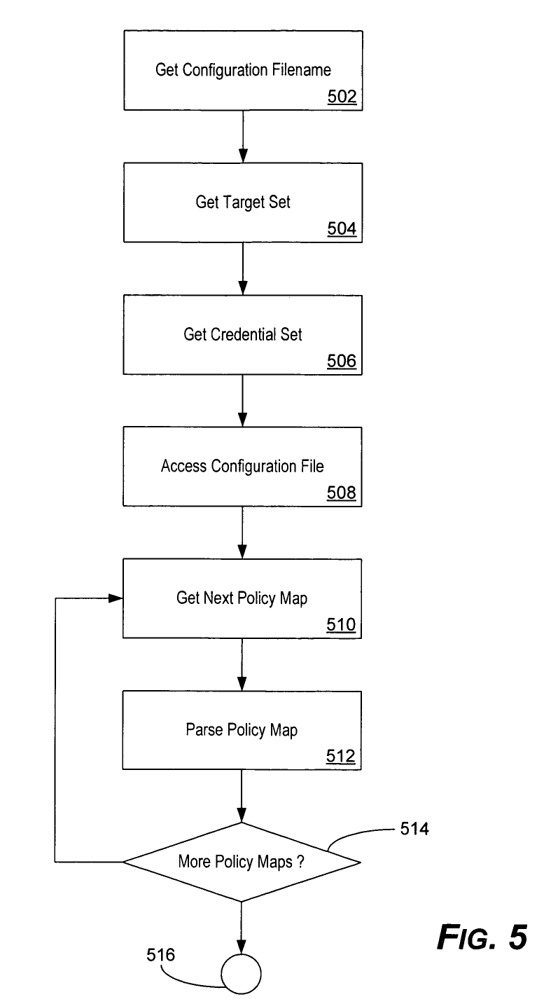

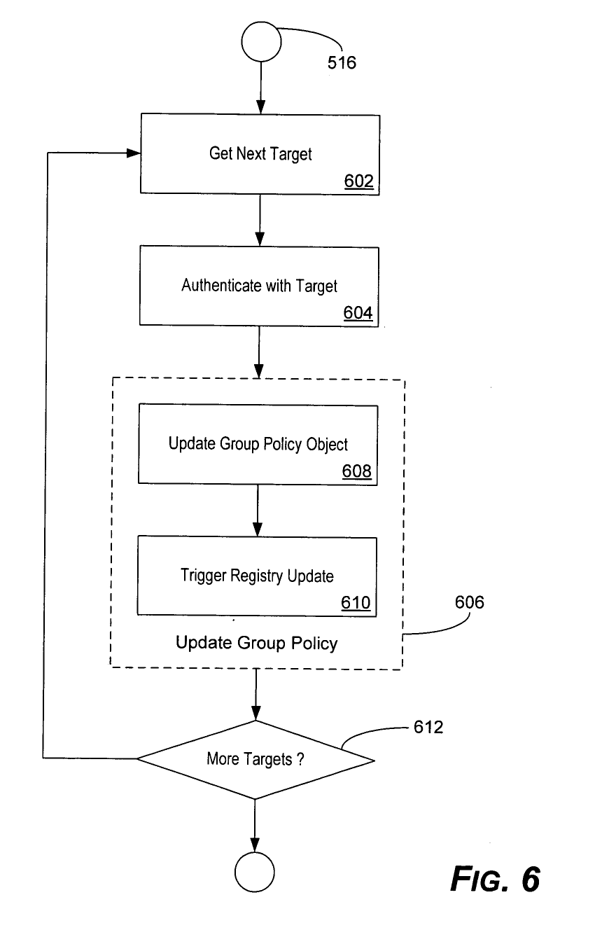

Example steps for configuration of group policies in accordance with an embodiment of the invention will now be described with reference to FIGS. 5 and 6. Each of the steps depicted in FIGS. 5 and 6 may be performed by the group policy configuration tool 312 (FIG. 3). In an embodiment of the invention the group policy configuration tool 312 is invoked at a command line interface (CLI) of the computer 102 (FIG. 1) along with command line parameters. In alternate embodiments, the group policy configuration tool 312 is invoked from a graphical user interface (GUI) of the computer 102 (FIG. 1), is embedded in the operating system 302, polls the configuration file repository 302, is pushed a group policy configuration file 314, 316, 318, and/or participates in a group policy configuration file 314, 316, 318 publish-subscribe system.

At step 502, a group policy configuration filename may be retrieved. For example, the group policy configuration tool 312 (FIG. 3) may retrieve the group policy configuration filename from the command line parameters. The steps depicted in FIGS. 5 and 6 may be repeated for each group policy configuration filename in the command line parameters.

At step 504, a set of references to target computers such as computers 202, 204, 206, 208, 210, 212, 214 (FIG. 2) may be retrieved, for example, from the command line parameters. The referenced set of target computers may be an arbitrary set of computers 202, 204, 206, 208, 210, 212, 214 without regard for organizational topology. Each element of the set may be a name of the target computer and may include qualification such as a network domain in which the target computer resides. At step 506, a set of authentication credentials may be retrieved, for example, from the command line parameters. The set of authentication credentials may include authentication credentials (e.g., a username and a password) for each computer in the set of target computers.

At step 508, a group policy configuration file 314, 316, 318 (FIG. 3) may be accessed. For example, a group policy configuration file 314, 316, 318 with a name corresponding to the group policy configuration filename retrieved at step 502 may be located, opened and read in from the configuration file repository 320. The group policy configuration file 314, 316, 318 may contain one or more policy maps such as policy map 402 (FIG. 4). In some embodiments of the invention, for example, where the group policy configuration tool is located at the target computer, steps 504 and 506 may be omitted.

At step 510, a next (or an initial) policy map 402 (FIG. 4) may be retrieved, for example, from the group policy configuration file 314, 316, 318 (FIG. 3). At step 512, the policy map 402 may be parsed. For example, the policy map 402 may be specified in an extensible markup language and the group policy configuration tool 312 may parse the extensible markup language in order to construct a representation of the policy map 402 suitable for storage in volatile system memory 106 (FIG. 1).

At step 514, it may be determined if there are more policy maps to parse. If there are more policy maps to parse, a process may return to step 510. Otherwise, the process may progress to step 602 (FIG. 6). The circle 516 depicted in both FIG. 5 and FIG. 6 is a flowchart connector that connects the steps depicted in FIG. 5 with the steps depicted in FIG. 6.

Referring now to FIG. 6, a next (or an initial) target computer may be selected, for example, from the set of target computers 202, 204, 206, 208, 210, 212, 214 (FIG. 2) retrieved at step 504 (FIG. 5). At step 604, authentication may occur with the selected target computer. For example, the group policy configuration tool 312 (FIG. 3) may authenticate with one of the computers 202, 204, 206, 208, 210, 212, 214 utilizing corresponding credentials from the set of authentication credentials retrieved at step 506.

At step 606, one or more group policies of the target computer may be updated in accordance with the policy map 402 (FIG. 4). Step 606 may itself include one or more sub-steps. For example, as depicted in FIG. 6, step 606 includes step 608 and 610.

At step 608, a group policy object of the target computer may be updated. For example, the group policy configuration tool 312 (FIG. 3) may utilize the group policy COM object 310 to update the group policy object 306. At step 610, a registry update may be triggered. For example, the newly updated group policy object 306 may be applied to the registry 304. In an embodiment of the invention, once the updated group policy object 306 has been applied to the registry 304, the group policy configuration tool 312 has successfully configured the target computer with the group policy or policies specified by the policy map(s) in the group policy configuration file 314, 316, 318.

At step 612, it may be determined if there are more target computers to be updated. If there are more target computers to be updated, then the process may return to step 602. Otherwise, in an embodiment of the invention, each computer in the set of target computers has been efficiently configured with a new set of group policies.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented method of group policy configuration comprising:
retrieving at least one policy map for mapping at least one group policy to a registry, each policy map comprising a policy map registry section field specifying at least one section of the registry;
parsing said at least one policy map; and
updating said at least one group policy corresponding to said at least one policy map.

2. The method of claim 1, wherein:
the method further comprises:
retrieving at least one policy configuration filename, each policy configuration filename corresponding to a policy configuration file, each policy configuration file comprising said at least one policy map; and
accessing the policy configuration file; and
parsing said at least one policy map comprises parsing the policy configuration file corresponding to said at least one policy configuration filename.

3. The method of claim 1, wherein updating said at least one group policy comprises updating at least one group policy object of a computer operating system.

4. The method of claim 1, wherein:
the registry is a computer operating system registry; and
updating said at least one group policy comprises updating the computer operating system registry.

5. The method of claim 1, wherein:
the method further comprises retrieving a set of references to target computers; and
updating said at least one group policy comprises updating said at least one group policy at each computer referenced by the set of references to target computers.

6. A computerized system for group policy configuration comprising:
a registry of system information comprising a plurality of sections;
at least one policy map for mapping at least one group policy to the registry, each policy map comprising a policy map registry section field specifying at least one of the plurality of sections of the registry; and
a group policy configuration tool configured to, at least:
retrieve said at least one policy map;
parse each policy map; and
update said at least one group policy corresponding to said at least one policy map.

7. The system of claim 6, wherein:
the system further comprises at least one policy configuration file;
said at least one policy configuration file comprises said at least one policy map; and
retrieving said at least one policy map comprises accessing said at least one policy configuration file.

8. The system of claim 6, wherein:
the system further comprises a group policy component object model (COM) object; and
the group policy configuration tool is further configured to update said at least one group policy with the group policy COM object.

9. The system of claim 6, wherein:
the system further comprises a computer operating system comprising:
the registry; and
at least one group policy object capable of specifying each group policy; and
updating said at least one group policy comprises updating said at least one group policy object of the computer operating system.

10. The system of claim 9, wherein:
the computer operating system further comprises a group policy map schema; and
the system further comprises at least one group policy configuration file structured in accordance with the group policy map schema.

11. A computer-readable medium having thereon a data structure for group policy configuration comprising a policy map for mapping at least one group policy to a registry, the policy map comprising:
a policy map description comprising alphanumeric text providing information about the group policy;
a policy map registry section field specifying at least one section of the registry; and
a first registry variable policy map field for mapping at least some of said at least one group policy to a first type of registry variable of the registry.

12. The medium of claim 11, wherein:
the registry comprises a plurality of types of registry variable; and
the policy map further comprises a second registry variable policy map field for mapping at least some of said at least one group policy to a second type of registry variable of the registry.

13. The medium of claim 12, wherein each registry variable policy map field comprises at least one name-value pair associating a registry key name with a registry variable value.

14. The medium of claim 13, wherein the registry key name corresponds to a registry key name in a policy map schema.

15. The medium of claim 11, wherein the policy map further comprises a policy map registry area field specifying at least one of a plurality of areas of the registry, the plurality of areas of the registry comprising:
a local machine area for registry entries associated with a computer; and
a user area for registry entries associated with at least one user of the computer.

16. The medium of claim 11, wherein said at least one group policy comprises a group policy associated with at least one user of a computer.

17. The medium of claim 11, wherein said at least one group policy comprises a group policy specifying security settings.

18. The medium of claim 11, wherein:
the registry comprises a plurality of sections organized in a hierarchy; and
specifying said at least one section of the registry comprises specifying a path through the hierarchy.

19. The medium of claim 11, wherein the policy map comprises extensible markup language.

20. The medium of claim 19, wherein each of the policy map description, the policy map registry section field, and the first registry variable policy map field is an extensible markup language element.
